(19) United States
(12) Patent Application Publication
(10) Pub. No.: US 2016/0305401 A1
(43) Pub. Date: Oct. 20, 2016

(54) Wind Turbine Rotating Tower Assembly with a Motorized Pivoting Tail Unit

(71) Applicant: Nourian M TETRAULT, Gasport, NY (US)

(72) Inventor: Nourian M. Tetrault, Gasport, NY (US)

(21) Appl. No.: 15/100,727

(22) PCT Filed: Dec. 30, 2014
(86) PCT No.: PCT/US14/72670

§ 371 Date: Jun. 1, 2016

Related U.S. Application Data
(60) Provisional application No. 61/922,391, filed on Dec. 31, 2013.

(51) Int. Cl. F03D 7/02; F03D 13/20

(52) U.S. Cl. CPC F03D 7/0212; F03D 13/20; F05B 2270/30

(57) ABSTRACT

A wind turbine for residential lots has a lower stationary inner tube supporting an upper outer tube rotatable about the inner tube. The upper tube supports a shaft supporting a generator, series of angled wide-width blades producing increased torque, and an elongated high-angled nose cone deflecting wind to an outer blades area increasing effective wind-speed providing power output of a turbine of about 120-130 feet; a second section of upper tube supporting a hinged-tail having a pivotable solid planar section hingedly attached to an open planar section fixedly attached to the upper tube; a computer-controlled actuator causing solid planar section to pivot into the wind at a pre-determined setting causing the upper tube to rotate turning the blade's plane of rotation out of the wind reducing their rotational velocity eliminating overheating of the generator providing for it to continue producing power in winds greater than 60 mph.

### CROSS-REFERENCE TO RELATED APPLICATIONS

This is a Patent Cooperation Treaty Application of Provisional Application No. 61/922,391 filed on Dec. 31, 2013.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to wind turbines and, more particularly, to a device for maintaining powered rotation while eliminating the danger of overheating.

The background information discussed below is presented to better illustrate the novelty and usefulness of the present invention. This background information is not admitted prior art.

Early wind turbines were commercial and by the end of 1986 about 6,700 wind turbines, mostly less than 100 kW generated about 550 million kWh/year. In 2005 output increased to 59,012 MW. By year-end 2009, the USA supplied 22.1% of global wind energy followed by China (16.3%), Germany (16.2%), Spain (11.5%) and India (6.8%). By 2010, worldwide wind energy capacity reached 194,000 MW, which was 2% of global energy supply. Increasing need to replace conventional sources of energy with renewable energy is expected to continue to drive the market for wind power generation over the next decade. Wind consumes no fuel for continuing operation with no emissions and zero pollution directly related to electricity production.

Global climate change, energy costs, and a desire to be off of the grid all contribute to the continued interest in wind power. Currently, residential wind energy is the fastest growing sector in the renewable energy market. There is good reason to believe that there will be much growth for years to come. Inversely correlated, however, is a continued decrease in residential lot size. DimensionsInfo reported that the current median average lot size in the United States is 8,750 square feet or a little over ⅕ of an acre. In the 1990 most lots in America measured 14,680 square feet. The number fell to 12,870 square feet eight years later. The prognosis is the average lot size in USA will decrease further. This trend appears to be global. The Urban Development Institute of Australia reported that over the past 10 years alone, lot sizes in that country have decreased in size by 29 per cent. A growing population and rising demand for real estate is likely to be behind this trend.

Zoning codes control whether a wind mill may be installed in a given location. The number of zoning jurisdictions estimated by the United States Department of Energy in 2008 was approaching 40,000. The height of wind turbines for use on residential lots varies depending, in part, on the zoning restrictions of the lot. Wind turbine height in generally reported as “hub-height”. The hub height of a wind turbine is the distance from the turbine platform to the rotor of an installed wind turbine and indicates how high the turbine stands above the ground. Commercial scale turbines (greater than 1 MW) are typically installed at 262 feet or higher, while small-scale wind turbines (approximately 10 kW) are installed on shorter towers.

Wind turbine height restrictions, in general, are concerned with safety issues and residential zoning requirements recognize this. Although, residential zoning restrictions differ among governmental entities, they are not too different from the following example of requiring that the set-back distance of a wind turbine tower must be 1½ times the height of the tower. Thus, a set-back distance of 1½ times the height of the tower would require a 130 foot tower to be sited on a lot that is no smaller than 195′×195′=38,025 square feet, which is nearly one acre (43, 560 sq. ft.). Clearly, as shown above, the vast majority of residential lots are considerably less than that. However, in addition to tower height restrictions based on lot size, most suburban townships have a general zoning height restriction of 40 feet.

### SUMMARY

The inventive concept of the present invention relates to low height wind turbines providing for homeowners and small business to have a wind turbine on today's typically sized residential lots. In addition to being within the height regulations required by most residential zoning codes, the turbines following the principles of the inventive concept are able to: continuously generate power even in high winds, eliminate overheating of the turbine's generator, deliver the power of a commercial height tower, and are affordable to build.

For each wind turbine, large or small scale, there is a maximum wind speed, called the survival speed, that poses a danger to the turbine. The survival speed of commercial wind turbines is in the range of 40 m/s (144 km/h, 89 MPH) to 72 m/s (259 km/h, 161 MPH). The most common survival speed is 60 m/s (216 km/h, 134 MPH). When winds occur over the maximum rated for a given turbine, the turbine must prevent its blades from going faster than their survival speed in order to prevent the wind turbine's generator from overheating. To do this, large commercial wind turbines reduce the speed of their blade's rotation using a hydraulic system to turn the plane of rotation of the blades out of the wind. Smaller wind turbines use their tail to turn their blade's plane of rotation out of the wind. However, as each of these systems turn their blade's plane of rotation away from the wind, eventually they each will suffer “kick-out”, which is the point that that the turbine stops generating power. The survival speed of presently available residential wind turbines is in a range of about 8-38 mph; above that wind speed the tail will push the blades out of the wind causing “kick-out” and a cessation of power generation. Thus, presently available wind turbines are unable to utilize winds over 40 mph.

The principles of the present invention provide for wind turbine systems in compliance with residential lot zoning restrictions and that are able to maintain power production even in high winds to generate the amount of power expected from some commercially sized turbines.

Wind turbines of the present invention have a hub height of only 30 feet, meeting zoning requirements, yet produce the same power output of a wind turbine having a hub height of 120-130 feet. Such enhanced power output is possible because the inventive concept includes having four blades of a width that supplies approximately 400 percent more surface area then other turbines. Having such wide blades is possible because of the four inch diameter shaft that is able to support the blades. The increased width of the blades coupled with their angled shape provides for increased torque providing for the enhanced power output. In addition to supporting the blades, the enhanced sized shaft supports the generator, two large diameter steel plates, and an enlarged nose cone that extends outward from the blades at approximately 20 percent of the blades diameter, and provides an anchor for the blade support struts to which the nose cone is secured. It should be understood that in a standard residential wind turbine, such an enlarged nose cone is of no value to the production of power because of their open-centered design through which the wind will travel to no effect, but for a turbine built according to the inventive principles the increase in power production due to the presence of an enlarged nose cone is substantial. The weight and design of the steel plates provides for the plates to act as flywheels providing for the system to run more smoothly and efficiently even in the swirling winds that are more prevalent at lower altitudes. Adding to these enhanced effects is the aero-dynamically large-sized conically shaped nose cone that, in the turbine illustrated, extends outward from the blades at approximately 20 percent of the blades diameter, which is this example is seven feet from the blades that have a diameter of 32 feet as measured from blade tip to blade tip and has sides angled at approximately 60 degrees, which increases the aero-dynamic properties of the system by deflecting the wind to the outer blade area resulting in increasing the effective speed of the wind giving the system extra power. The increased wind speed on the nose cone also helps to turn the system to follow the prevailing winds.

The example horizontal wind turbine, illustrated herein, also provides for a swivel tower and a two-section hinged-tail attached to the swivel tower in cooperation with a computer controlled actuator that will position the tail in relation to the wind at pre-determined settings. The swivel tower system, of the present example, consists of a rotatable, topmost, outer tube supported by a bottom, stationary tube. The top outer tube supports the blades, generator, steel plates, nose cone, and the hinged-tail with its computer controlled actuator. The two part hinged-tail has a non-solid planar section and a solid planar section. The non-solid planar section of the tail is situated adjacent and fixedly connected to the outer tube and hingedly connected to the solid planar section of the tail that is spaced away from the tower. In low to moderate winds, both planar sections of the tail are in the same plane that is perpendicular to the plane of rotation of the blades. The computer controlled actuator in cooperation with an actuator motor regulates the position of the solid planar section of the tail to respond to changes in wind speed. Such computer controlled actuators are used to produce movement when given a signal to drive motion in mechanical systems. In the present invention, the computer controlled actuator can be set to cause the actuator motor to move the tail in response to the computer sensing either a pre-determined rpm of the blades or the power output of the generator. When either of the pre-determined settings is sensed by the computer, the actuator instructs the actuator motor to move the solid, planar section of the hinged tail into the wind to reduce the rotational speed of turbine blades, thus avoiding the generator overheating and possibly failing. To do this, the computer directs the actuator motor to provide incremental force to turn the solid section of the wind turbine's hinged tail. As the plane of the tail approaches being parallel to the plane of blade rotation, the increased pressure of the wind impinging on the tail causes the upper tower to rotate about the lower tower to turn the blade's plane of rotation out of the wind, thus reducing the blades rpm and eliminating overheating of the generator.

Circular bearings or bushings positioned between the top and bottom tubes of the tower assist in the rotation. A top thrust bearing, sitting atop the stationary lower, inner tower cylinder, supports the weight of the outer, upper tower cylinder including the blades, steel plates, tail, and generator.

The sensitivity of this system provides for the generator to continue generating maximum power even in the high winds that result in other systems suffering “kick-out”, i.e., cessation of power production. Even at wind speeds of 70 mph the wind turbines of the present invention keep producing without any fear of generator burn-out. All of the above described advantages are available in addition to savings of about 15-25 percent over the cost of currently available 120-130 foot tower turbine systems. Considering the demand for alternative “green” sources of energy, there is a real market-place need for the wind turbines of the present invention that can match the power output of even 130 foot towers at reduced cost.

The inventive concept also employs blade torque instead of blade speed to generate electric power. This is accomplished by using a blade width to blade length ratio of 1 to 4, which differs significantly from the industrial standard of blade width to blade length ratio closer to 1 to 12. The torque of this system is also increased by using specific blade angles that favor power over speed. These wide torque-driven blades are connected by support struts between the blades and from blades to front support plate.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a transparent elevation view of an exemplary wind turbine of the present inventive concept.

FIG. 2 is an exploded view of the wind turbine's tail, as shown in FIG. 1.

FIG. 3 is a view of the inner and outer tubes and related bearings of the wind turbine.

FIG. 4 is a transparent elevation view illustrating the position of the tail in a moderate wind.

FIG. 5 is a plan view of the tail as illustrated in FIG. 4.

FIG. 6 is a plan view of the tail illustrating the position of the tail in a higher wind.

### A LIST OF THE REFERENCE NUMBERS AND PARTS OF THE INVENTION TO WHICH NUMBERS REFER

2 Blades.

4 Top outer tube of tower 12.

6 Bottom inner tube of tower 12.

8 Generator.

10 Wind turbine.

12 Tower.

14 Support bearings.

15 Top situated bearings inside tube 6.

16 Nose cone.

17 Bearings inside tube 6.

18 Universal pilot turnbuckle.

20 Solid section of pivoting tail.

22 Linear actuator rod.

24 Open section of pivoting tail.

26 Actuator motor.

27 Platform supporting actuator motor.

28 Actuator computerized controller.

30 Pivoting tail.

32 Hinges of tail 30.

36 Shaft supporting the plate 42 which supports the blade.

40 Struts supporting blade.

42 Steel plate.

46 Steel plate.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. It is well-known that wind turbines differ in size and shape for several reasons, such as the size of the lot on which the turbine will be sited, the style of turbine, horizontal or vertical, for example, and the amount of power to be generated. Therefore, the embodiments described herein are provided with the understanding that the present disclosure is intended as illustrative and is not intended to limit the invention to the embodiment described herein.

The present invention is directed towards wind turbines that consist of a series of blades width-sized and angled for maximum torque production when struck by sufficiently strong winds, so that as the blades rotate they, in turn, rotate the supporting shaft (central rotor) that provides the generator with the mechanical energy the generator uses to generate electricity. The principles of the present invention provide wind turbines that are able to: generate the amount of power expected from some commercially sized turbines, continue generating power even in winds at velocities of 60-70 mph, eliminate the danger of overheating the generator, and yet are sized for use on small, residential lots. Accordingly, the present example of the inventive concept illustrated is a wind turbine of approximately 30 feet in height that will not suffer from the phenomenon referred to as “kick-out” and, is able to continue generating power at wind velocities of over 60 mph without any fear of overheating the generator.

In essence, the inventive concept enables a wind turbine to continue functioning even at wind velocities exceeding 60 mph by providing for continuous rotation of the blades even in the wind velocities that will cause “kick-out” of other turbines. This is accomplished by having a system that continuously and incrementally moves the blades to positions of reduced wind velocity when required. The principles of the inventive concept provide for a computer that senses when a pre-determined wind survival speed is reached. At this point the computer directs the motor of the computer controlled actuator to continuously and incrementally move the turbine's tail relative into the wind that, in turn, increase the force of wind on the solid section of the hinged tail causing the tail to rotate the upper tube about the lower tube, causing the plane of the blades rotation to be moved out of the wind, thus reducing the rpm of the blades and eliminating overheating of the generator. Additionally, two steel plates supported by the shaft supply the function of a fly wheel, that is, contribute the centrifugal force that keeps the blades turning longer when the wind force is reduced or the wind direction changes. Turning now to the drawings, how to make and use a turbine exemplary of these principles will be described illustrated.

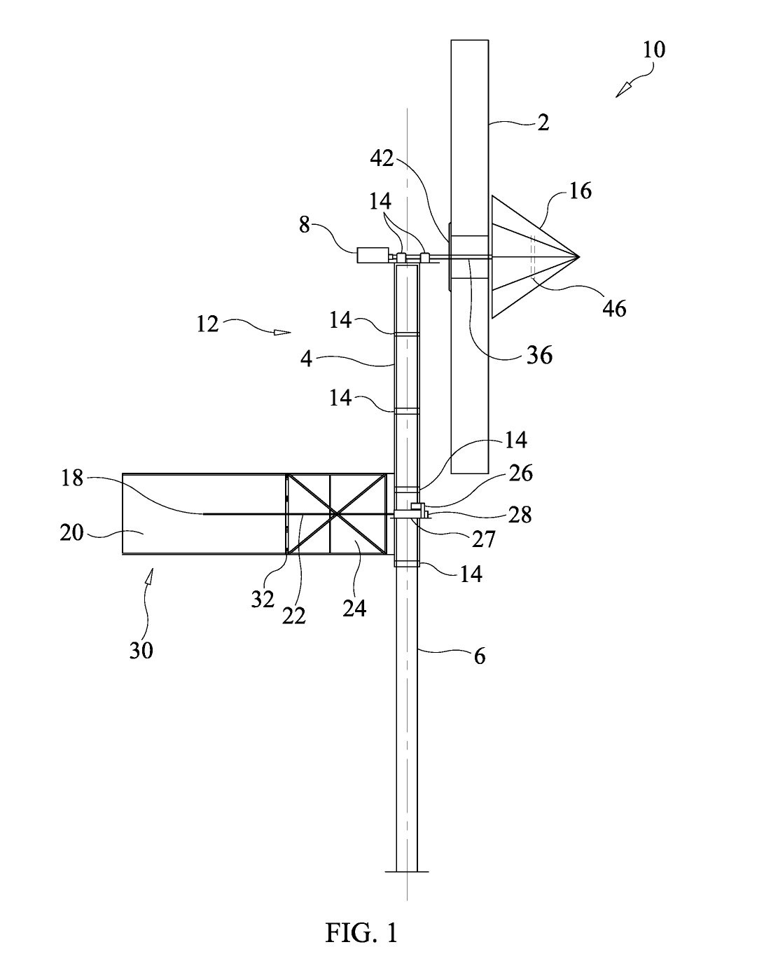

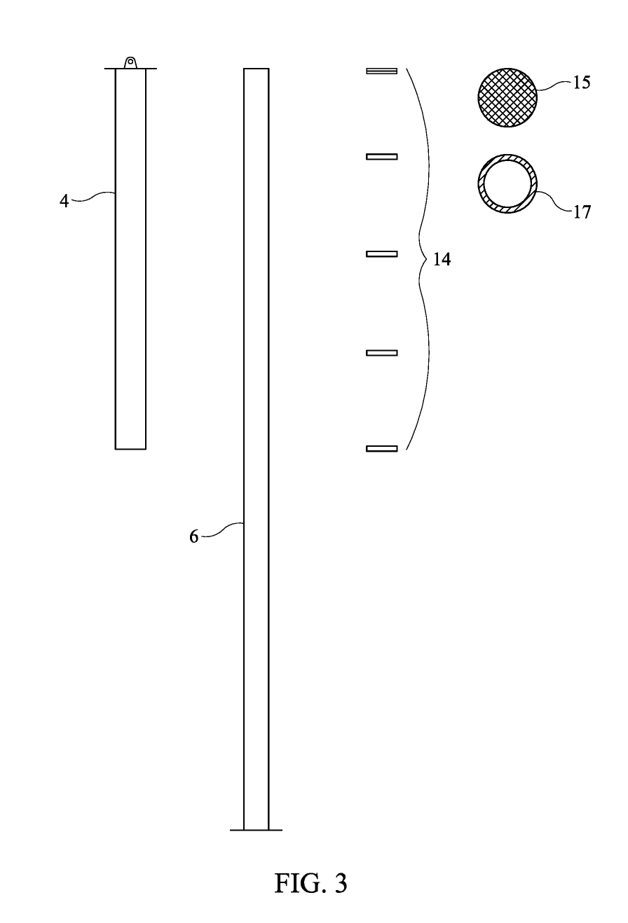

FIGS. 1-4, viewed together, illustrate the structural components of exemplary wind turbine 10. Wind turbine 10 consists of tower 12 that in this example is made up of rotatable top outer tube 4 having a diameter and stationary bottom inner tube 6 having a diameter less than that of top outer tube 4. The larger diameter of top tube 4 provides for it to be positioned atop and about the top-most part of bottom inner tube 6. Outer tube 4 rests securely upon bearings 15 (illustrated in FIG. 3) positioned out of sight on the top of inner tube 6. Bearing 17 (illustrated in FIG. 3) is secured, out of sight, along the inside perimeter of inner tube 6 to help the outer tube rotate while maintaining a secure fit between the inner and outer tubes. Circular support bearings 14, in this example, are ½″×1″×12″ long strips of Delrin® plastic. There are four strips parallel to each other at each location inside the top and bottom tubes of the tower acting as bearings. Bottom inner tube 6 is welded to grounded platform 44 that is bolted to a concrete pad (not shown). Outer top tube 4 supports all of the functioning components of the wind turbine. An upper section of outer top tube 4 supports shaft 36 sized to support generator 8, blades 2, cone 16, and two steel plates. Shaft 36, in this example, is 4 inches in diameter and is secured to the top surface of upper outer tube 4 and supported there by pillar block bearings 14. Blades 2 rotate as wind impinges on them, causing shaft 36 (supplies the rotor function) to spin. Spinning shaft 36 provides mechanical energy to generator 8. Generator 8 converts mechanical energy into electricity. Before extending through blades 2, shaft 36 extends through and supports circular steel plate blade support 42 and continues through smaller steel plate 46 that is not visible within enlarged nose cone 16. Shaft 36 supports blades 2 and anchor blade support struts 40. The mass of steel plates 42 and 46 provides the function of a flywheel to help blades 2 maintain their spin for an extended period of time even when the wind direction shifts greatly or when the wind is not continuous. Aero-dynamically shaped enlarged nose cone 16 extends outward from the blades a distance of approximately 20 percent of the blades diameter with its conical sides angled at approximately 60 degrees deflect the wind to the outer blade area thus increasing the effective speed of the wind giving the system extra power. The increased wind speed on the nose cone also helps to turn the system to follow the prevailing winds. A lower section of outer top tube 4 supports pivotable hinged-tail, two planar sectioned tail 30, actuator motor 26, and actuator controller 28. Also supported by the lower section of outer top tube 4 is platform 27 that supports actuator motor 26 and actuator controller 28. Pivotable, hinged-tail 30 is positioned at a lower elevation on tower 12 than blades 2 to have access to more wind. In this example, hinges 32 divide tail 30 into two hingedly connected sections: solid, planar, outer tail pivoting section 20 manufactured of a solid material for maximum wind impact, and inner tail pivoting section 24 designed to be mostly open to the wind. Supported by inner tail non-solid pivoting section 24 is linear actuator rod 22. Universal pilot 18 is essentially a turnbuckle that assists in pivoting tail section 20. When the wind reaches a predetermined speed, linear actuator rod 22 and universal turnbuckle 18, directed by actuator controller 28, cause solid, pivotable, outer tail 20 to pivot into the wind, causing the increased force of the wind on outer tail 20 to cause top tube 4 to rotate which turns the plane of rotation of the blades out of the direction of maximum force of the prevailing wind to save the generator from overheating. The actuator controller, sensitive to even small changes of wind velocity, causes the movements of the outer tail to be incremental, yet continuous, and smooth. The ability of the actuator to employ the tail to rotate top outer tube 4 provides for the system to rapidly respond to wind direction changes. When the wind speed diminishes, the solid planar section of the outer tale re-assumes its resting orientation of being perpendicular to the plane of rotation of the blades. Other small wind turbines are not able to respond to wind direction changes in the same manner as the present invention and often go into the “kick-out” state where the generator stops producing power.

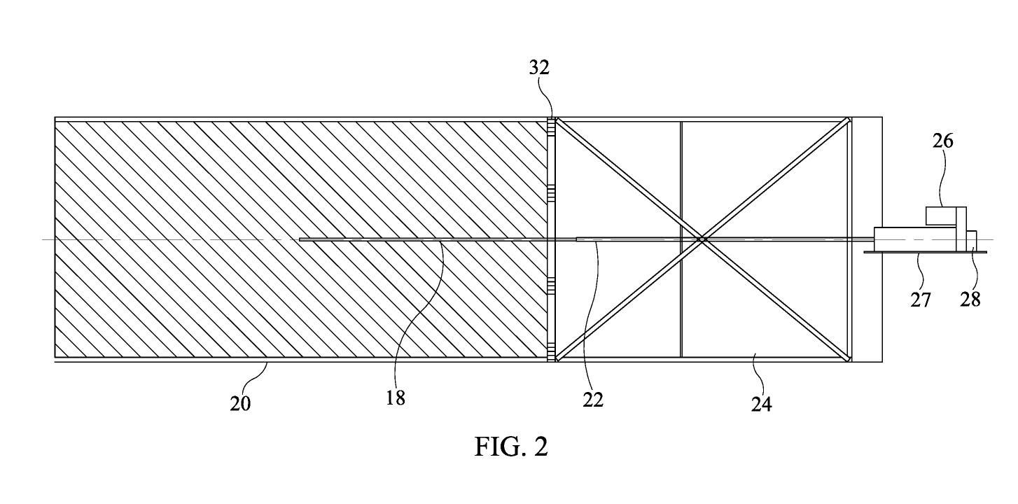

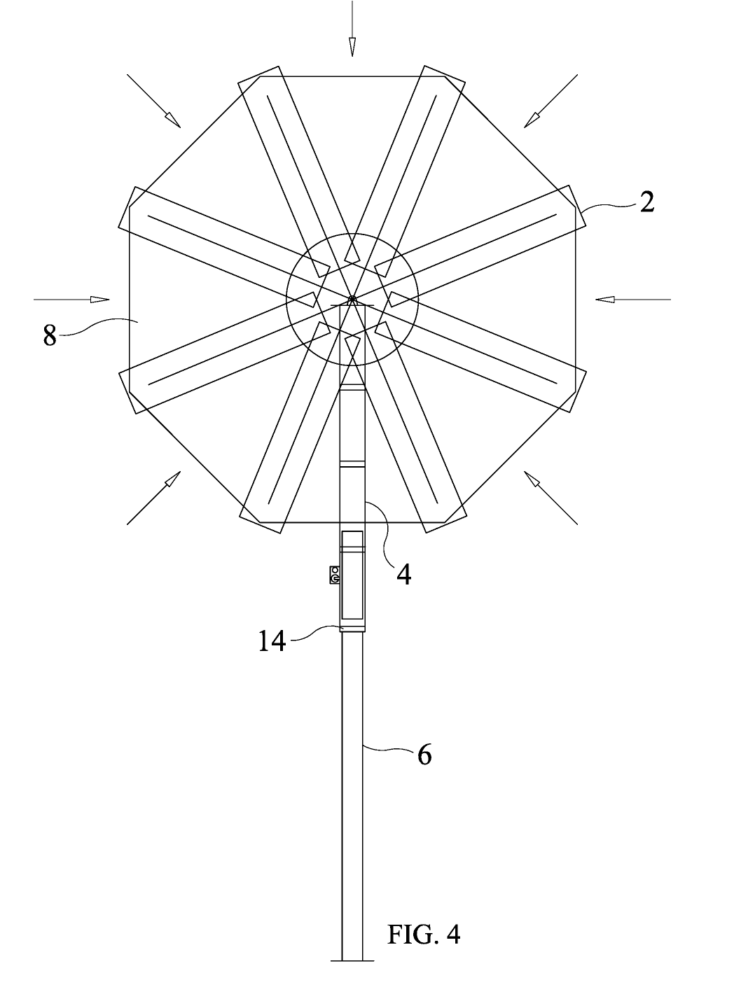

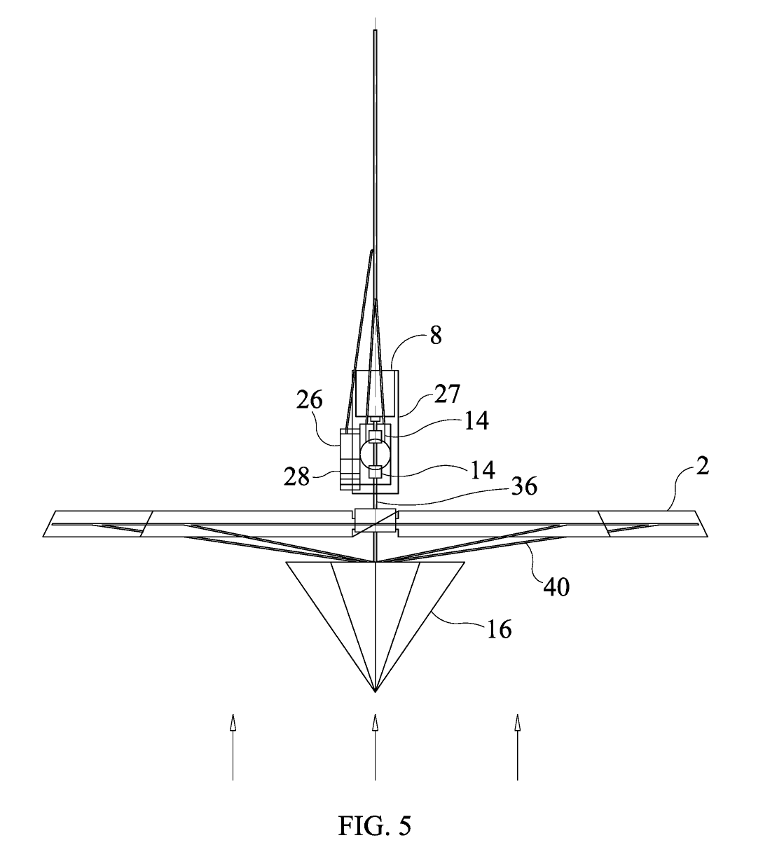

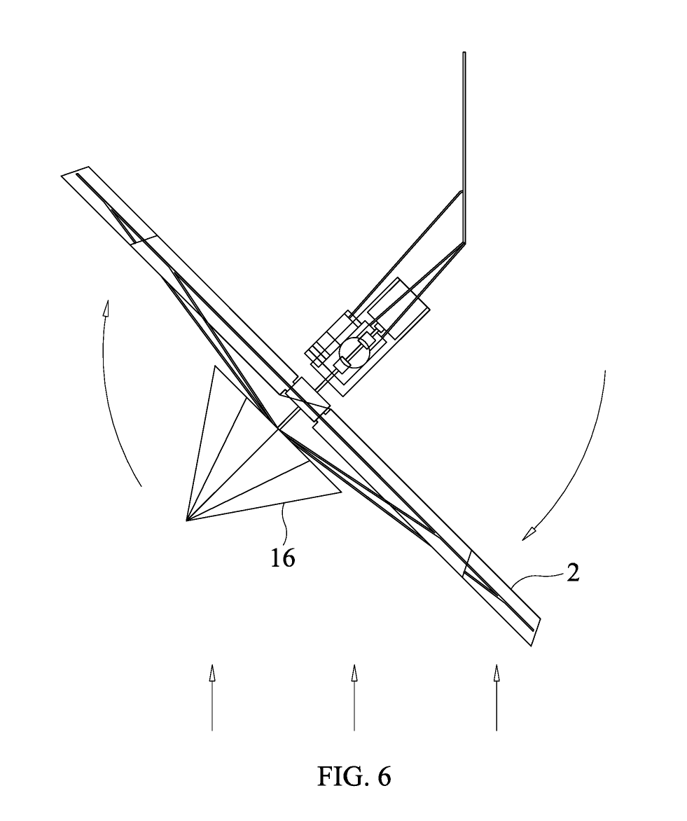

FIG. 2 illustrates an exploded view of tail 30 of wind turbine 10, as shown in FIG. 1. Tail 30 is secured to rotating top outer tube 4 by actuating rod 22. Actuator motor 26 is controlled by an internal computer chip programmed to sense the speed or rpm of blades 2. When the rpm of blades 2 is less than or equal to the “rated” survival speed rpm, the actuator will remain “silent” and the tail will remain perpendicular to plane of rotation of blades 2, as is illustrated in FIGS. 4 and 5. When the computer senses that the rpm of the blades is exceeding the rated survival speed rpm, the computer will trigger actuator controller 28 to direct actuator motor 26 to provide the power to the actuator rod and the universal turnbuckle 18 to move the solid pivoting part 20 of tail 30 at its hinges into the wind, as illustrated in FIG. 6. The wind will then push against solid pivotable part 20 resulting in rotation of upper tube part 4 of tower 12 to push the blade's plane of rotation out of the high wind avoiding over heating of the generator while allowing the blades to continue their rotation and allowing the generator to produce continuous maximum output. As the winds increase, the tail will only pivot when the survival (maximum) speed of rotation of the blades is reached. Under the effect of high winds, the tail can rotate from being at an angle of 90 degrees from the plane of the blades to being parallel with the plane of the blades, so that rotation of the blades remains continuous. For example, if there was a 70 mph wind, the tail would turn only enough to keep the blades rotating just below or at their maximum output. At this speed the tail may only have to be turned 60 degrees with respect to the blades. It should be understood that the rotation of the tower as described, is just an example and that the inventive concept includes any means of rotating a single- or multiple-section tower.

Alternatively, the computer can monitor the generator's output to control the actuator. The computer is programmed to notify the actuator motor when the predetermined maximum value of the generator's power output is sensed by the computer so that the generator is not overworked. A control circuit connected to the generator will control the actuator. If the output of the generator exceeds its limit, the circuit will switch on telling the actuator to reduce the rotation of the blades until output is lowered back to maximum. If maximum output is not being produced the circuit will turn on to have the actuator move the tail until it is perpendicular to the blades.

It is to be understood that it is contemplated by the inventive concept that the support tower tubes can also be built by using fabricated self-supporting structures, including but not limited to squares, triangles, etc. For bracing, the towers use a cross-bracing or zig-zag pattern, similar to that of an erector set.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A wind turbine, comprising:
a tower sized for residential lot use having:
a lower stationary inner tube supporting
an upper outer tube rotatable about said inner tube;
a first section of said upper tube supporting:
a shaft sized to support a generator, a series of blades each constructed to have a width and angle tot produce increased torque in communication with said generator by said shaft for communicating mechanical energy from said blades to said generator, and an elongated high-angled nose cone so designed for the deflection of wind to an outer area of said blade increasing the effective wind speed to provide the power output of a wind turbine of about 120-130 feet in height, and
a second section of said upper tube supporting:
a hinged-tail having a pivotable solid planar section hingedly attached to an open planar section fixedly attached to said second section of said upper tube;
a computer controlled actuator in communication with an said solid planar section of said tail to cause it to pivot into the wind at a pre-determined setting to cause said upper tube to rotate to turn said blade's plane of rotation out of the wind reducing said blade's rotational velocity eliminating generator overheating to provide for said generator to continue to produce power in winds of greater than 60 mph.

2. The wind turbine, as recited in claim 1, wherein said shaft further supports two steel plates providing centrifugal force to cause said blades to maintain their rotation for an extended period of time even as the wind velocity decreases or the wind direction shifts greatly.

3. The wind turbine, as recited in claim 1, wherein said blades have a blade width to blade length ratio of 1 to 4.

4. The wind turbine, as recited in claim 1, wherein said tower has a hub height of 30 feet.

5. The wind turbine, as recited in claim 1, wherein said hinged-tail is secured to said tower at a lower elevation than said blades to have access to more wind.

6. The wind turbine, as recited in claim 1, wherein said shaft is 4 inches in diameter.

7. The wind turbine, as recited in claim 1, wherein said shaft is secured to a top surface of said upper outer tube and supported there by pillar block bearings.

8. The wind turbine, as recited in claim 1, wherein said upper outer tube has a larger diameter than said lower stationary inner tube.

9. The wind turbine, as recited in claim 1, wherein said nose cone extends outward in front of said blades to a distance of approximately 20 percent of the blades diameter.

10. The wind turbine, as recited in claim 1, wherein said nose cone has sides angled at approximately 60 degrees.

11. The wind turbine, as recited in claim 1, further including said nose cone aero-dynamically designed causing deflection of wind to an outer area of said blade increasing the effective wind speed to provide the same power output of a wind turbine of about 120-130 feet in height.

12. The wind turbine, as recited in claim 1, further including a sensor in a computer, said sensor set to sense a pre-determined value of said blade's rpm or said generator's power output.

13. The wind turbine, as recited in claim 12, further including said computer controlled actuator having an actuator motor in communication with said computer to receive direction from said computer.

14. The wind turbine, as recited in claim 13, further including said motor operatively connected to a linear actuator rod operatively secured to said open planar section of said tail and to said rotating upper outer tube to move said actuator rod.

15. The wind turbine, as recited in claim 14, further including said actuator rod operatively connected to a universal turnbuckle secured within said solid planar tail section to cause said turnbuckle to pivot said solid planar section of said tail into the wind.

16. The wind turbine, as recited in claim 15, further including said motor operatively connected to said linear actuator rod causing said linear actuator rod in conjunction with said universal turnbuckle to pivot said solid planar tail section into the wind, causing increased force of the wind on said outer tail to cause upper outer tube to rotate to turn the plane of rotation of said blades out of the direction of maximum force of the prevailing wind to save overheating said generator.

17. The wind turbine, as recited in claim 1, further including said upper outer tube rotatable about said inner tube having a diameter and said lower stationary inner tube having a diameter less than that of top outer tube providing for said outer tube to be positioned atop and about the top-most part of bottom inner tube.

18. The wind turbine, as recited in claim 1, wherein said inner tube is welded to a support platform.

19. A wind turbine, comprising:
a tower for siting on a residential lot having:
a lower stationary grounded inner tube supporting:
an upper outer tube rotatable about said inner tube;
an upper section of said upper outer tube supporting:
a shaft supporting:
a generator on a first end of said shaft;
a first steel plate followed by;
a series of wide angled blades operatively connected to said generator by said shaft;
a second steel plate, and
a high-angle, elongate nose cone on a second end of said shaft,
a lower section of said upper tube supporting:
a hinged-tail tail having a pivotable solid planar section hingedly attached to an open planar section fixedly attached to said lower section of said upper tube;
an actuator controller in communication with
an actuator motor operatively connected to a universal pivot positioned within said solid planar section of said tail to direct said solid tail section to pivot,
so that when a wind of sufficient force rotates said blades said shaft is caused to rotate to cause said generator to generate electricity;
said steel plates provide the centrifugal force to keep said blades in rotational motion as the wind force diminishes;
said enlarged nose cone extending outward from the blades a distance of approximately 20 percent of the blades diameter causes wind to be deflected to outer blade areas to increase effective wind speed to provide power output of a wind turbine of about 120-130 feet in height, and
said actuator controller, at a predetermined blade rotation velocity or at a predetermined generator output, to cause said actuator motor to pivot said solid planar section of said tail into the wind to cause it to experience an increase of wind force to cause said upper outer tube to rotate about said inner tube to cause said blades to reduce their rotational velocity to eliminate said generator overheating to provide continuous power production even in winds of greater than 60 mph.

20. A wind turbine, comprising:
a tower of a height to meet residential lot zoning restrictions constructed of:
a lower stationary tower tube rotatably connected to and supporting
an upper rotatable tower tube;
an upper section of said upper rotatable tower tube supporting:
a series of blades supported by a shaft, said blades angled to provide maximum movement under the force of the wind and width-sized to provide maximum torque,
a generator supported by a first end of said shaft, operatively connected via said shaft to said blades to generate electricity,
one or more circular steel plates supported by said shaft, said plates to provide centrifugal force to maintain said blade's movement during diminishing wind velocity, and
an enlarged nose cone supported by a second end of said shaft, said cone having its conical sides sufficiently high-angled and extending into the wind a distance of approximately 20 percent of the blades diameter to deflect the wind to an outer blade area to increase the effective wind speed to provide for said turbine to produce the same amount of power of a wind turbine having a tower height exceeding that required by residential lot zoning restrictions,
a lower section of said upper rotatable tower tube supporting:
a tail having
a non-solid planar section hingedly connected to a pivotable solid planar section;
an actuator, said actuator computer controlled to pivotably position said solid planar section of said tail in relation to the wind;
a sensor in the computer set to read a pre-determined value of the rpm of the blades or the power output of the generator to cause said computer to direct said actuator at said pre-determined value reading to move said solid, planar section of said tail incrementally into the wind to experience increased wind pressure to cause said upper rotatable tower tube to rotate about said lower stationary tower tube to bring said blade's plane of rotation into the wind to reduce said blade's rotational speed to avoiding said generator overheating, to provide said generator to continuously generate power even in wind velocities of over 60 mph.
